(19) United States
(12) Patent Application Publication
(10) Pub. No.: US 2010/0035200 A1
(43) Pub. Date: Feb. 11, 2010

(54) GAS-ASSISTED SYSTEM FOR FLUID DROPLET GENERATION IN AN ORAL CARE SYSTEM

(75) Inventors: Jozef Johannes Maria Janssen, Herten (NL); Bart Gottenbos, Budel (NL); Arjan Van Der Sande, Eindhoven (NL); Paulus Cornelius Duineveld, Drachten (NL); Jon Hayenga, Redmond, WA (US); John W. Pace, Bothell, WA (US); William Bryant, North Bend, WA (US); Martijn Van Baren, Joure (NL); Martijn Jeroen Dekker, Groningen (NL); Scott Hall, Issaquah, WA (US)

Correspondence Address: PHILIPS INTELLECTUAL PROPERTY & STANDARDS, PO BOX 3001, BRIARCLIFF MANOR, NY, 10510-8001, US

(73) Assignee: KONINKLIJKE PHILIPS ELECTRONICS N.V., EINDHOVEN (NL)

(21) Appl. No.: 11/722,493

(22) PCT Filed: Dec. 21, 2005
(86) PCT No.: PCT/IB05/54365

§ 371 Date: Oct. 27, 2009

Related U.S. Application Data
(60) Provisional application No. 60/638,226, filed on Dec. 22, 2004.

(51) Int. Cl. A61C 17/02

(52) U.S. Cl. 433/32; 433/88

(57) ABSTRACT

An oral care system using a stream of fluid droplets for cleaning teeth includes a hand-held portable oral care device having a handle portion with a nozzle at a forward end thereof, a source of dental fluid and a source of pressurized gas, between 10-30 bar, both located in the handle portion. The system also includes a base unit which includes a reservoir tank for pressurized air, a reservoir tank for fluid, and a compressor connected to the gas reservoir. The handle includes valves for controlling the release of pressurized gas and fluid from the handle to the nozzle. Connecting ducts are arranged from the fluid and pressurized gas source to the nozzle such as to accelerate the pressurized gas droplets from the nozzle to a desired velocity.

This invention relates generally to oral care systems using a stream of fluid droplets for cleaning, and more particularly concerns a system for assisting in fluid droplet generation and acceleration using pressurized gas.

Oral care devices using high speed fluid droplets are known. One system is shown in International Publication No. WO 2004/034923A1, which involves an oral care system which includes providing fluid at high pressure to a nozzle which produces a spray of droplets. Such a system is often referred to as a “liquid-only” system, because the fluid itself is delivered at high pressure, using a high pressure pump, to a nozzle which then creates the droplets at or beyond the nozzle orifice. Such systems, however, are disadvantageous because of the relatively small size of the droplets typically produced, the rapid deceleration of droplets beyond the nozzle orifice, and the corresponding high velocity necessary to produce effective cleaning.

Another example of a droplet stream oral cleaning system is shown in International Publication No. WO 9408533A1, which includes a source of fluid and a compressor for producing pressurized fluid for the creation of droplets directed with relative high velocity to the teeth for cleaning.

Still another droplet stream cleaning system is shown in International Publication No. WO 02/13721A3, which includes a source of pressurized gas, fluid and powder directed at high pressure toward the user's teeth. A hand-held portion of the unit is tethered to a base unit which contains liquid and a source of pressurized gas. The fluid is under high pressure when it reaches the nozzle. Such a tethered system requires more power and is often cumbersome to use.

Another fluid droplet system is shown in U.S. patent application Ser. No. 60/537,690, filed on Jun. 26, 2003, titled , “Droplet Jet System for Cleaning”, which is owned by the assignee of the present invention, the contents of which are incorporated by reference herein.

Accordingly, the present invention is an oral care system using a stream of fluid droplets for cleaning, comprising: a hand-held portable oral care device having a handle portion with a nozzle at a forward end thereof; a source of fluid; a source of pressurized gas within the range of 0.5-1000 bar; and means for controlling the movement of pressurized gas and fluid to the nozzle in such a manner that fluid droplets are generated and then accelerated by the pressurized gas to a velocity of between 20 and 400 meters per second.

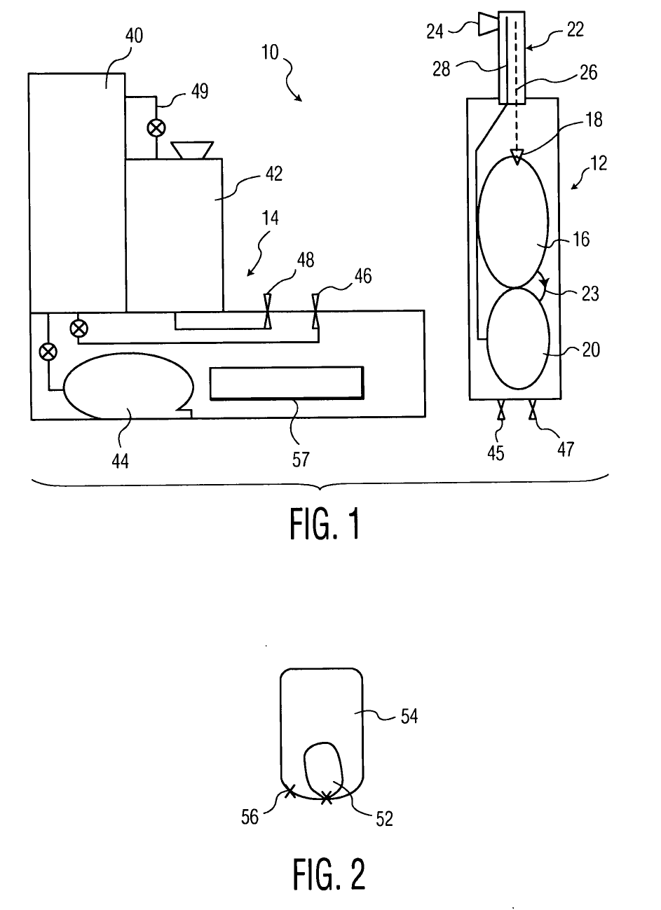

FIG. 1 is a schematic drawing showing the overall system of the present invention.

FIG. 2 shows a variation of the portion of the embodiment of FIG. 1.

In general, the present invention is directed toward a gas-assisted fluid droplet stream oral cleaning system. Typically, the gas will be air, but it can be other types of gas as well. Low pressure gas accelerates fluid droplets generated at a nozzle portion of the system.

The system of the present invention is shown in FIG. 1, generally indicated by the numeral 10. It includes a hand-held, portable handle unit 12 and a base unit 14. The handle unit 12 is separable from, i.e. not tethered to, base 14. Handle unit 12 includes a high pressure air tank 16 with a control valve 18, which regulates the flow and pressure of the pressurized gas to the nozzle, a tank 20 for liquid, such as water, a stem portion 22 and a nozzle 24 at the free, remote end of stem 22. Connecting ducts 26 and 28 extend from the air tank and liquid tank 20, respectively, through stem 22 to nozzle 24.

Typical pressure in the air tank 16 is between 0.5-100 bar and preferably between 5-50 bar. The volume of the tank 16 will be typically in the range of 10-200 cc, and preferably between 30-100 cc. Air delivered from tank 16 to nozzle 24 via control valve 18, used to accelerate liquid droplets, is less than 10 bar and preferable less than 5 bar. The volume of fluid tank 20 is between 20 and 100 cc.

The base unit portion 14 of the system includes a large volume, high pressure air storage reservoir tank 40, a large volume fluid storage reservoir 42 and a compressor/pump 44 which is used to pressurize gas storage reservoir 40. The high pressure air tank 16 in the handle can be pressurized through a high pressure connection 45 on the handle and a mating connection 46 on the base unit 14, the connection on the base unit extending to the gas storage resevoir 40. The handle fluid storage tank 20 can be refilled from the fluid storage tank 42 through a connection 47 on the handle and mating connection 48 on the base unit. The transfer of fluid can be accomplished with pressure from the high pressure air storage reservoir 40, as indicated by connection line 49. The volume of reservoir 40 will typically be in the range of 10-200 cc and preferably 20-80 cc.

Alternatively, a separate pump (not shown) can be used to move liquid from storage reservoir 42 in the base unit to storage tank 20 in the handle.

It is also possible, as an alternative, to have a pump in the handle 12 to pressurize air tank 16. The use of a pressurized container in the handle 12, however, as opposed to a separate pump in the handle or as opposed to use of a tethered arrangement between a base unit and a handle has an advantage of being efficient for the user. It is typically difficult to operate an air pump with batteries. In the preferred embodiment, there is no pump or motor inside the handle. It is thus light and easy to operate.

Handle unit 12 also includes a control valve 23, connecting the high pressure air tank 16 to the fluid storage tank 20, which regulates the flow and pressure of the fluid delivery to the nozzle. In operation, fluid, such as water, is directed from storage tank 20 through its associated connecting duct 28 to nozzle 24, such that the fluid pressure upon reaching the nozzle is less than 10 bar, preferably less than 5 bar and fluid droplets are generated as one function of the nozzle prior to their exiting the nozzle orifice. The fluid droplets are accelerated by the pressurized gas from tank 16, prior to, at, and beyond the nozzle orifice. In the embodiment shown, the resulting droplet velocity produced by the system will be typically 30-200 meters per second for relatively large droplets of more than 30 micrometers in diameter, with larger velocities being possible for smaller droplets.

The velocity of the gas in the handle will be generally between 20-400 meters per second, and preferably between 50-200 meters per second. With the above arrangement, a relatively safe droplet velocity can be used with large size droplets. The fluid pressure at the nozzle will be relatively small, as discussed above, since the droplets are accelerated by the flow of pressurized gas. Hence, higher droplet velocities are possible, since high fluid pressure at the nozzle is no longer necessary to achieve the desired high velocity. The necessity of high pressure at the nozzle to achieve a desired high droplet velocity in other systems was a significant disadvantage for those systems.

In a variation of the embodiment of FIG. 1, it is possible to have the liquid and the gas in one container in the handle, as shown in FIG. 2. A fluid container 52 is positioned inside gas container 54. A valve 56 is used to remove condensation within the gas container.

Referring again to FIG. 1, the base unit 14 can include various sensors, shown generally at 57, including a level indicator for fluid reservoir 42, a pressure sensor in the gas reservoir 40, and a temperature sensor for the liquid. Similar sensors can be used in the handle 12.

The temperature of the pressurized gas and the liquid in the handle can be important to the overall comfort of the user. When the pressurized gas moves from tank 18 under pressure to the nozzle 24, the temperature of the gas can drop substantially, producing a cold air stream on the teeth, which can be uncomfortable. To counteract that effect, the liquid in the liquid reservoir 20 can be heated to compensate, or the gas in the hand-held unit can be heated by a separate heating element (not shown) in the handle, which is actuated when the handle is in contact with the base unit.

In another feature, compressor 44 in the base unit can have both a rapid operation mode and a slow operation mode for refilling the gas reservoir in the base unit. The choice depends on the amount of noise which can be tolerated. The “slow fill” operation is quieter. The base unit can include several additional features, including several means to prevent use by children, including a simple clipping system connecting the handle to the base station, a code (unknown to the children) which is entered at the base unit, or a dead-man's switch.

A lock and key system can also be used in the base unit so that only authorized handles can be used with the base unit. Furthermore, an I.D. tag can be used to store statistical data concerning use of the system, such as the number of brushing times or the number of uses by various handles. Still further, the fluid reservoir 42 in the base unit can include a particular physical connection to prevent users from filling the reservoir with unauthorized liquid.

Control systems can be used on both the gas and liquid tanks in the handle to provide desired control over the droplet flow. Still further, various pressure protection means can be built into the system, including means for manually or automatically discharging pressure in the handle after a certain period of time following charging and/or discharging the pressure in the base unit. Automatic pressure relief valves may also be provided to prevent an unsafe buildup of pressure in the system.

This arrangement will produce cleansing of the teeth, including interdentally, when the fluid droplets are generated within the desired ranges of size and effective velocity.

The hand-held device of FIG. 1 can be adapted for interdental cleaning. The face of the nozzle is configured to mate with the human interdental area, in effect sealing the interdental area and assisting in the droplets moving accurately through the interdental gap.

Although a preferred embodiment of the invention has been disclosed for purposes of illustration, it should be understood that various changes, modifications and substitutions may be incorporated in the embodiment without departing from the spirit of the invention which is defined by the claims which follow.

1. An oral care system using a stream of fluid droplets for cleaning, comprising:
a hand-held portable oral care device having a handle portion with a nozzle at a forward end thereof;
a source of fluid;
a source of pressurized gas within the range of 0.5-100 bar; and
means for controlling the movement of pressurized gas and fluid to the nozzle in such a manner that fluid droplets are generated and then accelerated by the pressurized gas to a velocity of between 30 and 200 meters per second.

2. The system of claim 1, wherein the fluid source is a container with a volume of between 20 and 100 cc.

3. The system of claim 1, wherein the velocity of the droplet accelerating gas is within the range of 20 and 400 meters per second.

4. The system of claim 1, wherein the velocity of the droplet accelerating gas is within the range of 50 and 200 meters per second.

5. The system of claim 1, including means for heating the fluid.

6. The system of claim 1, including means for heating the pressurized gas.

7. The system of claim 1, wherein the source of gas is a pressurized container located in the handle and the source of fluid is a container in the handle.

8. The system of claim 7, wherein the pressurized gas container has a volume of between 30 and 100 cc.

9. The system of claim 1, wherein the system includes a base unit having a high pressure gas reservoir and a fluid reservoir and a compressor connected to the gas reservoir, and wherein the base unit includes connection elements which mate with connection elements on the handle for refilling and pressurizing the gas container and the fluid container in the handle.

10. The system of claim 1, including means for discharging pressure in the gas reservoir in the handle and/or the base unit.

11. The system of claim 1, wherein the source of fluid is located within the source of pressurized gas in the handle.

12. The system of claim 8, wherein the fluid reservoir in the base unit is configured to accept only authorized fluid.

13. The system of claim 9, wherein the connection elements on the base unit and the handle are configured to prevent connection of unauthorized handles to the base unit.
